(19) United States
(12) Patent Application Publication
(10) Pub. No.: US 2007/0056951 A1
(43) Pub. Date: Mar. 15, 2007

(54) Microchip

(75) Inventor: Souichi Takigawa, Hamamatsu-Shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: YAMAHA CORPORATION, Hamamatsu-Shi (JP)

(21) Appl. No.: 11/530,417

(22) Filed: Sep. 8, 2006

(30) Foreign Application Priority Data
Sep. 12, 2005 (JP) 2005-263498

(51) Int. Cl. F27D 11/00

(52) U.S. Cl. 219/432

(57) ABSTRACT

A microchip is formed on a chip base (composed of a silicone resin) so as to include a temperature controlled portion, which is controlled in temperature by way of a channel and which is brought into contact with Peltier elements. At least one recess is formed in the outer periphery of the temperature controlled portion so as to surround the temperature controlled portion except for a prescribed area allowing the channel to pass therethrough. The recess is formed deep or runs through the chip base in its thickness direction, thus reducing the amount of heat transmitted from the temperature controlled portion to the external area of the chip base. Hence, it is possible to perform precise temperature control with respect to the temperature controlled portion of the microchip.

### BACKGROUND OF THE INVENTION

1. Field of the Invention

The present invention relates to microchips having temperature controlled portions for performing local temperature control.

This application claims priority on Japanese Patent Application No. 2005-263498, the content of which is incorporated herein by reference.

2. Description of the Related Art

Microchips are formed using thin-plate chip bases in which channels and barrels are formed. Samples are subjected to isolation, composition, and observation, and cells and bacteria are cultivated in channels and barrels of microchips. It is necessary for microchips to precisely and locally control temperature at temperature controlled portions such as these channels and barrels in microchips.

Various technologies have been developed to locally control temperature at the temperature controlled portions in microchips. For example, Japanese Unexamined Patent Application Publication No. H11-127900 teaches a first known technology in which heating electrodes are arranged so as to heat analysis electrodes in microchips, thus controlling the temperature of the analysis electrodes of the microchips. Japanese Unexamined Patent Application Publication No. H13-235474teaches a second known technology in which a temperature controller is arranged to control temperature independently with respect to islands composed of heat conductors. This allows each island's temperature to be controlled; hence, it is possible to control the temperature of a sample container arranged in contact with each island. Furthermore, the website of Citizen Co. Ltd. (whose URL is http://www.citizen.co.jp/med/field/index.html) teaches a third known technology in which a heatsink having small Peltier elements is arranged for a one-side surface of a chip having temperature controlled portions, thus controlling the temperature by use of Peltier elements.

In the first known technology in which heating electrodes are simply arranged near analysis electrodes, it is difficult to cool the analysis electrodes. As a result, when the setting temperature is close to the atmospheric temperature, it is difficult to precisely control temperature. Similar to the first known technology, the second known technology taught in Japanese Unexamined Patent Application Publication No. H13-235474 teaches that islands are simply heated; hence, it is difficult to cool sample containers arranged in contact with the islands; that is, it is difficult to perform precise temperature control.

The third known technology may allow temperature controlled portions to be heated and cooled by use of Peltier elements. However, when adjacent temperature controlled portions are heated at different temperatures, heat conduction may occur between them via a chip base. This indicates that the temperature of one temperature controlled portion may be influenced by the temperature of another temperature controlled portion; hence, it becomes difficult to perform precise temperature control. Both of the first and second known technologies also suffer from the same problem in which heat conduction occurs via the chip base. This shows the difficulty in performing precise temperature control of adjacent temperature controlled portions.

### SUMMARY OF THE INVENTION

It is an object of the present invention to provide a microchip whose temperature controlled portion is precisely controlled in temperature by suppressing heat conduction.

In the first aspect of the present invention, a microchip includes a chip base having a thin-plate shape, a temperature controlled portion that is installed in the chip base and is temperature controlled, and a heat insulator that is formed in the outer periphery of the temperature controlled portion on the chip base. Herein, the heat insulator reduces the amount of heat transmitted from the temperature controlled portion to the external area thereof, thus performing precise temperature control of the temperature controlled portion.

The heat insulator is realized using air whose heat conductivity is smaller than the heat conductivity of the chip base composed of a resin or a glass, for example.

In a second aspect of the present invention, the aforementioned microchip further includes a channel interconnected with the temperature controlled portion on the chip base, wherein the heat insulator is formed around the temperature controlled portion except for a prescribed portion allowing the channel to pass therethrough. That is, the temperature controlled portion is surrounded by the heat insulator except for the minimum required area allowing the channel to pass therethrough, whereby it will hardly be influenced by the surrounding temperature; hence, it is possible to perform precise temperature control of the temperature controlled portion.

In the above, the heat insulator is formed to discontinuously surround the temperature controlled portion, whereby the temperature controlled portion is supported by the chip base by way of the broken area of the recess. Alternatively, the heat insulator is formed to continuously surround the temperature controlled portion.

In the above, at least one recess is formed to serve as the heat insulator in the outer periphery of the temperature controlled portion. That is, the heat insulator can be realized by a simple structure which guarantees a noticeable reduction of the amount of heat transmitted from the temperature controlled portion to the external area in the microchip. The recess can be formed to run through the chip base in the thickness direction.

Furthermore, the recess is filled with a heat insulating material instead of air. By filling the recess with the heat insulating material whose heat conductivity is lower than the heat conductivity of air, it is possible to further reduce the amount of heat transmitted from the temperature controlled portion to the external area of the microchip, and it is possible to improve the strength of the chip base. As the heat insulating material, it is possible to use a prescribed material (e.g., urethane foam and polystyrene foam) whose heat conductivity is higher than the heat conductivity of air but is lower than the heat conductivity of the material (e.g., a silicone resin or polydimethyl-siloxane) forming the chip base.

### BRIEF DESCRIPTION OF THE DRAWINGS

These and other objects, aspects, and embodiments of the present invention will be described in more detail with reference to the following drawings, in which:

FIG. 1A is a plan view showing a microchip in accordance with a preferred embodiment of the present invention;

FIG. 1B is a cross-sectional view taken along line B-B in FIG. 1A;

FIG. 2 is a plan view showing a first variation of a microchip in accordance with the present invention;

FIG. 3 is a plan view showing a second variation of a microchip in accordance with the present invention;

FIG. 4A is a perspective view showing a temperature distribution of a microchip having recesses around a temperature controlled portion;

FIG. 4B is a perspective view showing a temperature distribution of a microchip having no recess around a temperature controlled portion;

FIG. 5A is a cross-sectional view showing a microchip having a temperature controlled portion;

FIG. 5B is a cross-sectional view showing a microchip having shallow recesses in the outer periphery of a temperature controlled portion;

FIG. 5C is a cross-sectional view showing a microchip having deep recesses in the outer periphery of a temperature controlled portion;

FIG. 5D is a cross-sectional view showing a microchip having through recesses in the outer periphery of a temperature controlled portion;

FIG. 5E is a graph showing temperature distributions of the microchips shown in FIGS. 5A to 5D;

FIG. 6A is a cross-sectional view showing a microchip having recesses of small widths in the outer periphery of a temperature controlled portion;

FIG. 6B is a cross-sectional view showing a microchip having recesses of larger widths in the outer periphery of a temperature controlled portion;

FIG. 6C is a cross-sectional view showing a microchip having recesses of further large widths in the outer periphery of a temperature controlled portion;

FIG. 6D is a graph showing temperature distributions of the microchips shown in FIGS. 6A to 6C;

FIG. 7A is a plan view showing a microchip in which no recess is formed around a temperature controlled portion;

FIG. 7B is a plan view showing a microchip in which recesses are formed around a temperature controlled portion;

FIG. 7C is a plan view showing a microchip in which a pair of recesses are formed on opposite sides of a temperature controlled portion; and

FIG. 7D is a graph showing temperature distributions of the microchips shown in FIGS. 7A to 7C.

### DESCRIPTION OF THE PREFERRED EMBODIMENT

The present invention will be described in further detail by way of examples with reference to the accompanying drawings.

### 1. Preferred Embodiment

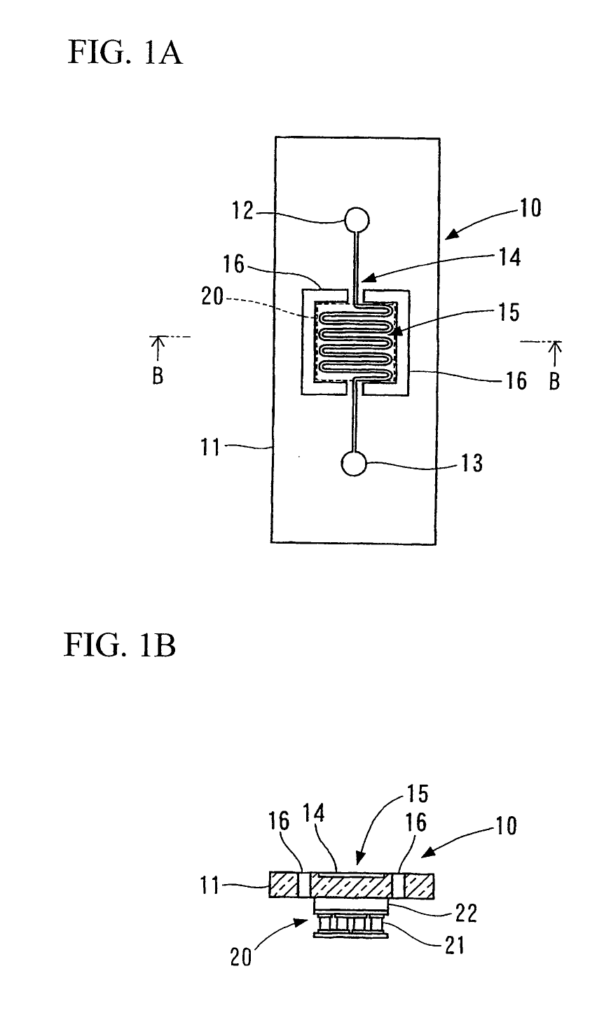

FIG. 1A is a plan view showing a microchip 10 in accordance with a preferred embodiment of the present invention, and FIG. 1B is a cross-sectional view taken along line B-B in FIG. 1A. The microchip 10 has a thin-plate chip base 11, which is composed of a resin or a glass, for example. The microchip 10 is used for the cultivation of cells and bacteria and is also used for causing chemical reactions and for the isolation of chemical substances.

The chip base 11 of the microchip 10 has two barrels 12 and 13 and a channel interconnecting therebetween. Each of the barrels 12 and 13 and the channel 14 is formed by partially recessing the surface of the chip base 11 in its thickness direction. A temperature controlled portion 15 is formed in the chip base 11. The temperature controlled portion 15 is positioned between the barrels 12 and 13 in connection with the channel 14, which winds through the temperature controlled portion 15. That is, temperature controlled portion 15 is formed in connection with the wound portion of the channel 14. Due to the winding of the channel 14, it is possible to increase the total area of the channel 14 passing through the temperature controlled portion 15. Thus, a fluid flows through the channel 14, which is formed in contact with the temperature controlled portion 15, between the barrels 12 and 13.

A temperature control device 20 is arranged in contact with the temperature controlled portion 15. The temperature control device 20 includes Peltier elements 21 and a temperature control portion 22. Each of the Peltier elements 21 is designed such that one terminal thereof is heated and the other terminal thereof absorbs heat in response to the direction of an electric current flowing therethrough. By controlling the direction and magnitude of an electric current applied to the Peltier element 21, it is possible to heat or cool the temperature control portion 22. The temperature control portion 22 is formed using a heat conductor, which is composed of copper, aluminum, or a prescribed alloy. Thus, the temperature control portion 22 is subjected to temperature control at a prescribed temperature, and the temperature controlled portion 15 of the chip base 11, which is positioned in contact with the temperature control portion 22, is also subjected to temperature control at the prescribed temperature. The temperature control portion 22 is not necessarily composed of a prescribed metal; hence, it can be composed of ceramics or resins having heat conduction properties, for example.

Since the chip base 11 is positioned in contact with the temperature control portion 22 of the temperature control device 20, the temperature controlled portion 15 is temperature controlled. Recesses 16 serving as heat insulators are formed in the outer periphery of the temperature controlled portion 15 of the microchip 10. The recesses 16 are formed at prescribed positions in the chip base 11. It is preferable that the recesses 16 be deeply recessed from the surface of the chip base 20, in which the barrels 12 and 13 and the channel 14 are formed, in the thickness direction toward the other surface close to the temperature control device 20. It may be further preferable that the recesses 16 be formed to run through the chip base 11 in the thickness direction.

The recesses 16 are formed around the outer periphery of the temperature controlled portion 15 and are positioned discontinuously therebetween at prescribed positions allowing the channel 14 to pass therethrough. This prevents the channel 14 from being broken by the recesses 16 in proximity to the temperature controlled portion 15. Of course, it is possible to form a single continuous recess 16 in the outer periphery of the temperature controlled portion 15. In this case, the temperature controlled portion 15 is supported by the chip base 11 by means of an independent member (not shown), for example. It is possible to form a plurality of recesses 16 discontinuously in the outer periphery of the temperature controlled portion 15, wherein the recesses 16 are positioned with prescribed distances therebetween or with varying distances therebetween, for example.

The microchip 10 is formed by way of embossed processing, injection molding, or etching performed on the chip base 11 including the barrels 12 and 13, the channel 14, and the recesses 16.

2. Variations

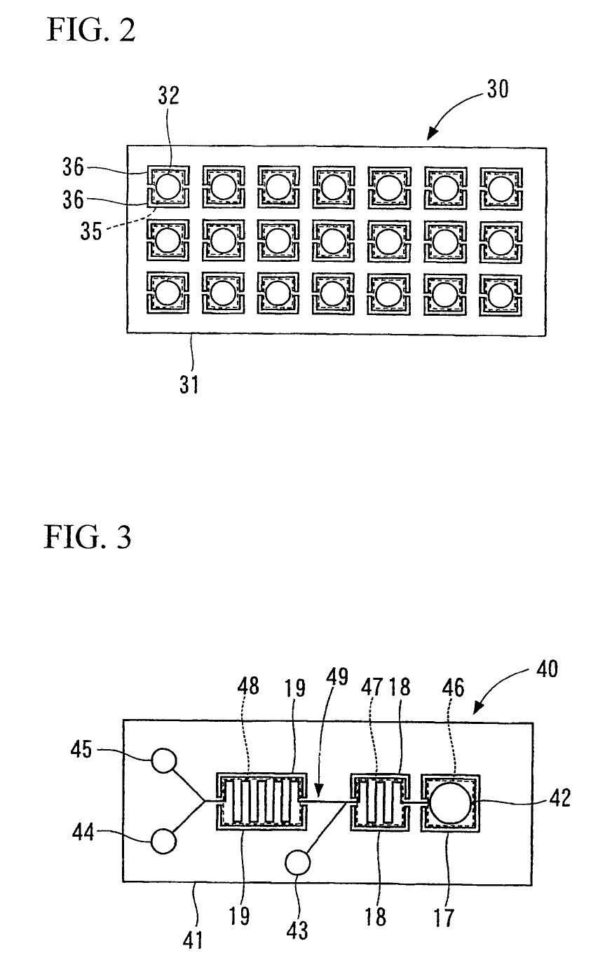

The present invention is not necessarily limited to the aforementioned embodiment regarding the microchip 10 shown in FIG. 1; hence, it is possible to present variations as shown in FIGS. 2 and 3. FIG. 2 shows a microchip 30 in which a plurality of barrels 32 are formed in relation to a plurality of recesses 36 serving as heat insulators on a chip base 31. The barrels 32 are respectively equipped with temperature controlled portions 35. Specifically, the recesses 36 are formed discontinuously around the outer periphery of the barrel 32 positioned in contact with the temperature controlled portion 35. The barrel 32 and the temperature controlled portion 35 are supported by the chip base 31 by way of the broken portions of the recesses 36.

FIG. 3 shows a microchip 40 in which four barrels 42, 43, 44, and 45 and three temperature controlled portions 46, 47, and 48 are formed on a chip base 41. The temperature controlled portion 46 is positioned in contact with the barrel 42. All of the barrels 42, 43, 44, and 45 are interconnected by way of a split channel 49, which winds in the temperature controlled portions 47 and 48. The split channel 49 allows the temperature controlled portions 46, 47, and 48 to be set to prescribed positions, wherein the temperature controlled portion 46 is positioned at the barrel 42. A single continuous recess 17 is formed in the outer periphery of the temperature controlled portion 46, recesses 18 are formed in the outer periphery of the temperature controlled portion 47, and recesses 19 are formed in the outer periphery of the temperature controlled portion 48. The recesses 17, 18, and 19 are appropriately positioned to allow the split channel 49 to pass therebetween.

In the aforementioned embodiment (see FIGS. 1A and 1B) and the aforementioned variations (see FIGS. 2 and 3), each of the channels 16, 17, 18, 19, and 36 is internally filled with air. It is possible to modify them in such a way that each of the channels 16, 17, 18, 19, and 36 is internally filled with a prescribed substance whose heat conductivity is lower than the heat conductivity of air. This further reduces the amount of heat that is transmitted externally from the temperature controlled portions 15, 35, 46, 47, and 48 to the recesses 16, 17, 18, 19, and 36. Alternatively, it is possible to fill the recesses 16, 17, 18, 19, and 36 with a heat insulating material whose heat conductivity is higher than the heat conductivity of air and is lower than the heat conductivity of materials forming the chip bases 11, 31, and 41. As the heat insulating material, it is possible to use foaming agents such as urethane foam and polystyrene foam. By filling the recesses 16, 17, 18, 19, and 36 with heat insulating materials, it is possible to increase the strength of the chip bases 11, 31, and 41. The recesses 16, 17, 18, 19, and 36 are not necessarily formed to continuously adjoin together in the outer peripheries of the temperature controlled portions 15, 35, 46, 47, and 48; hence, they can be shaped and positioned discontinuously with prescribed distances therebetween or with varying distances therebetween. In addition, two sets or three sets or more of the recesses 16, 17, 18, 19, and 36 can be formed in a multiple manner in the outer peripheries of the temperature controlled portions 15, 35, 46, 47, and 48, for example.

3. Shapes and Heat Insulating Effects of Recesses

Next, the shapes and heat insulating effects of the recesses 16 serving as heat insulators, which are installed in the microchip 10, will be described in detail.

(a) Effects of Recesses

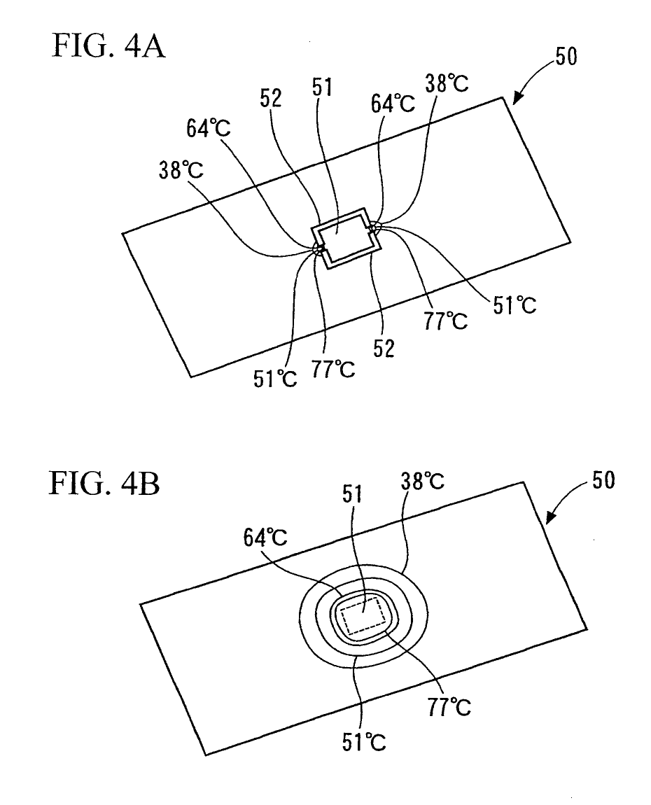

FIG. 4A shows a temperature distribution of a microchip 50 composed of a silicone resin (or polydimethyl-siloxane) in which recesses 52 serving as heat insulators are formed around a temperature controlled portion 51, and FIG. 4B shows a temperature distribution of the microchip 50 in which no recess 52 is formed. In both of FIGS. 4A and 4B, the microchip 50 is exposed to the atmosphere at room temperature (e.g., 25° C.), and the temperature of the temperature controlled portion 51 is controlled at 90° C. FIGS. 4A and 4B show constant temperature lines of 77° C., 64° C., 51° C., and 38° C. By forming the recesses 52 around the temperature controlled portion 51, it is possible to reduce the amount of heat externally transmitted from the temperature controlled portion 51 to the recesses 52. For this reason, the surrounding area of the temperature controlled portion 51 is not influenced by the temperature controlled portion 51 and is not increased in temperature.

In contrast, when no recess 52 is formed around the temperature controlled portion 51, heat conduction occurs by way of the chip base of the microchip 50, so that heat is transmitted from the temperature controlled portion 51 to its surrounding area. This may reduce the temperature of the temperature controlled portion 51 with ease, and the surrounding area of the temperature controlled portion 51, which is increased in temperature, may be enlarged.

As described above, it is possible to reduce the amount of heat transmitted from the temperature controlled portion 51 to its surrounding area by forming the recesses 52 around the temperature controlled portion 51. As a result, when the temperature controlled portion 51 is heated, it is possible to suppress the reduction of temperature of the temperature controlled portion 51 and the increase of temperature of the surrounding area of the temperature controlled portion 51. Similarly, when the temperature controlled portion 51 is cooled, it is possible to suppress the increase of temperature of the temperature controlled portion 51 and the reduction of temperature of the surrounding area of the temperature controlled portion 51. In short, it is possible to perform high-accuracy temperature control of the temperature controlled portion 51.

(b) Depths and Heat Insulating Effects of Recesses

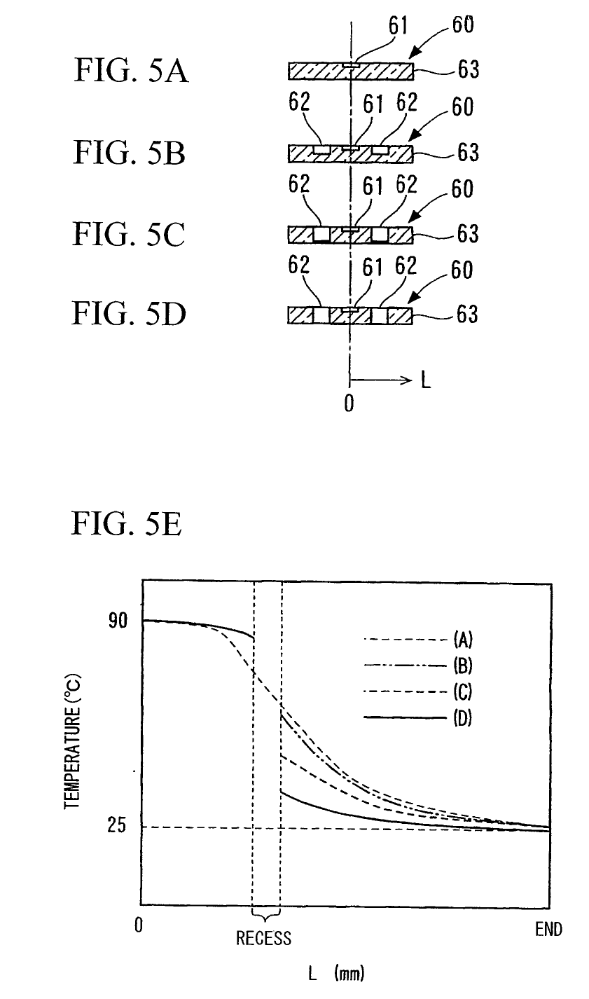

The relationships between the heat insulating effects and depths of recesses 62, which are formed around the temperature controlled portion 61 of a microchip 60, will be described with reference to FIGS. 5A to 5E. FIGS. 5A to 5D diagrammatically show cross-sectional shapes of microchips 60 having recesses 62 of different depth, and FIG. 5E shows temperature distributions measured at the surfaces of the microchips 60 shown in FIGS. 5A to 5D. The microchip 60 is composed of a silicone resin (or polydimethyl-siloxane) and is formed in a rectangular shape of 35 mm width, 70 mm length, and 1.0 mm thickness. Herein, the microchip 60 is exposed to the atmosphere at room temperature (e.g., 25° C.), and the temperature controlled portion 61 is heated to 90° C.

All the microchips 60 shown in FIGS. 5A to 5D have the temperature controlled portions 61 at the center portions thereof. In addition, recesses 62 are formed in the outer periphery of the temperature controlled portion 61. Each recess 62 is internally filled with air. The microchip 60 of FIG. 5A is illustrated for the purpose of comparison, and no recess is formed in the outer periphery of the temperature controlled portion 61. This may be expressed such that the depth of the recess 62 is zero in the microchip of FIG. 5A. In the microchip 60 of FIG. 5B, recesses 62 of 0.5 mm depth (which occupies 50% of the thickness of a chip base 63) are formed in the outer periphery of the temperature controlled portion 61. In the microchip 60 of FIG. 5C, recesses 62 of 0.9 mm depth (which occupies 90% of the thickness of the chip base 63) are formed in the outer periphery of the temperature controlled portion 61. In the microchip 60 of FIG. 5D, recesses 62 of 1.0 mm depth (which run through the chip base 63 in its thickness direction) are formed in the outer periphery of the temperature controlled portion 61.

FIG. 5E is a graph showing temperature distributions ranging from the center to the end in the width direction of the microchips 60 shown in FIG. 5A to 5D. In the graph of FIG. 5E, the horizontal axis represents a length L (mm), which is measured from the center (or an origin 0) of the microchip 60 in its width direction, and the vertical axis represents temperature. FIG. 5E clearly shows that, due to the formation of the recesses 62 around the temperature controlled portion 61, heat insulation is realized between the temperature controlled portion 61 and the external areas of the recesses 62. In the microchip 60 of FIG. 5A in which no recess is formed in the outer periphery of the temperature controlled portion 61, the temperature controlled portion 61 is reduced in temperature due to the heat conduction therefrom, but the outer periphery thereof is increased in temperature. In the microchip 60 of FIG. 5B, no temperature reduction appears in the temperature controlled portion 61; however, a temperature distribution similar to that of the microchip 60 of FIG. 5A appears in the external areas of the recesses 62. This indicates that heat insulating effects may be reduced relatively when the depth of the recesses 62 is approximately set to 50% of the thickness of the chip base 63.

In each of the microchips 60 shown in FIGS. 5C and 5D, no temperature reduction occurs substantially in the temperature controlled portion 61; hence, the external areas of the recesses 62 are controlled not to increase the temperature. This indicates that heat insulating effects are increased as the depth of the recesses 62, which are formed in the outer periphery of the temperature controlled portion 61, increases. That is, it is possible to realize high heat insulating effects in the microchip 60 of FIG. 5D in which the recesses 62 run through the chip base 63 in its thickness direction.

As described above, it is preferable that the depth of the recesses 62, which are formed in the outer periphery of the temperature controlled portion 61, be increased, and it is further preferable that the recesses 62 run through the chip base 63 in its thickness direction.

(c) Heat Insulating Effects and Widths of Recesses

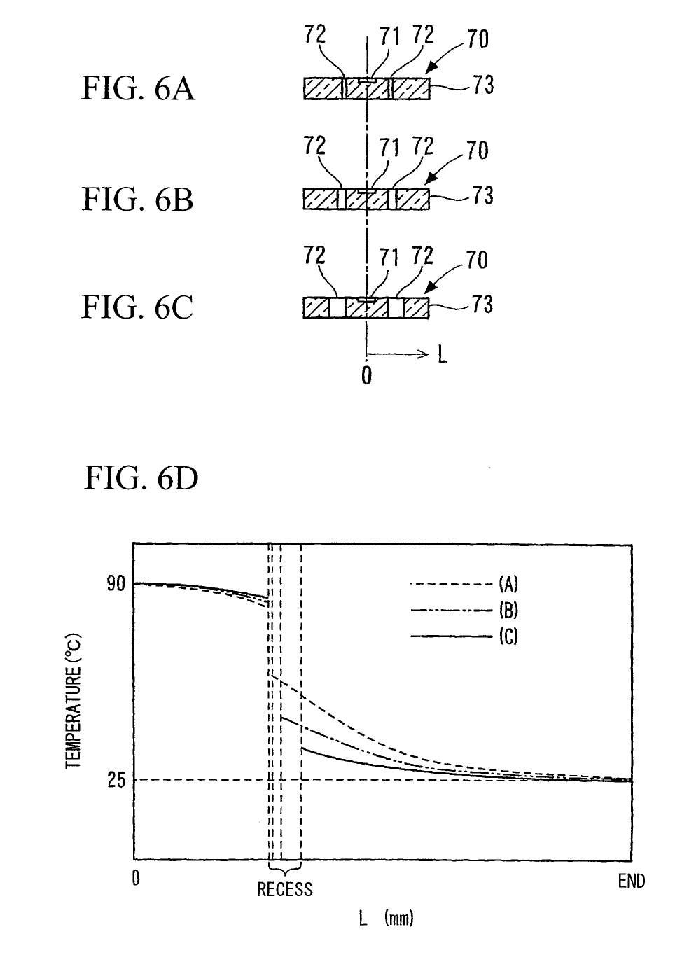

Next, the relationships between the heat insulating effects and widths of recesses 72 formed around temperature controlled portions 71 of microchips 70 will be explained. FIGS. 6A to 6C diagrammatically show cross-sectional shapes of microchips 70 having recesses 72 of different widths. FIG. 6D is a graph showing temperature distributions measured on the surfaces of the microchips 70 shown in FIGS. 6A to 6C. The microchip 70 is composed of a silicone resin (or polydimethyl-siloxane) and is formed in a rectangular shape of 35 mm width, 70 mm length, and 1.0 mm thickness. The microchip 70 is exposed to the atmosphere at room temperature (e.g., 25° C.), and the temperature controlled portion 71 is heated at 90° C.

Each of the microchips 70 shown in FIGS. 6A to 6C has a temperature controlled portion 71 at the center thereof in the width direction. The recesses 72 are formed in the outer periphery of the temperature controlled portion 71. All the recesses 72 shown in FIGS. 6A to 6C are formed to run through chip bases 73 in their thickness directions and are internally filled with air. Specifically, the microchip 70 of FIG. 6A has the recesses 72 of 0.2 mm widths, the microchip 70 of FIG. 6B has the recesses 72 of 0.5 mm widths, and the microchip 70 of FIG. 6C has the recesses 72 of 1.0 mm widths.

FIG. 6D shows temperature distributions of the aforementioned microchips 70, wherein the horizontal axis represents a length L (mm) measured from the center (i.e., an origin 0) in the width direction of the microchip 70, and the vertical axis represents temperature. FIG. 6D clearly shows that, as the width of the recesses 72 formed in the outer periphery of the temperature controlled portion 71 increases, a temperature reduction of the temperature controlled portion 71 decreases, and a temperature increase in the external areas of the recesses 72 is suppressed as well.

As described above, it is preferable that the recesses 72 formed in the outer periphery of the temperature controlled portion 71 be increased in width in order to increase heat insulating effects.

(d) Heat Insulating Effects and Shapes of Recesses

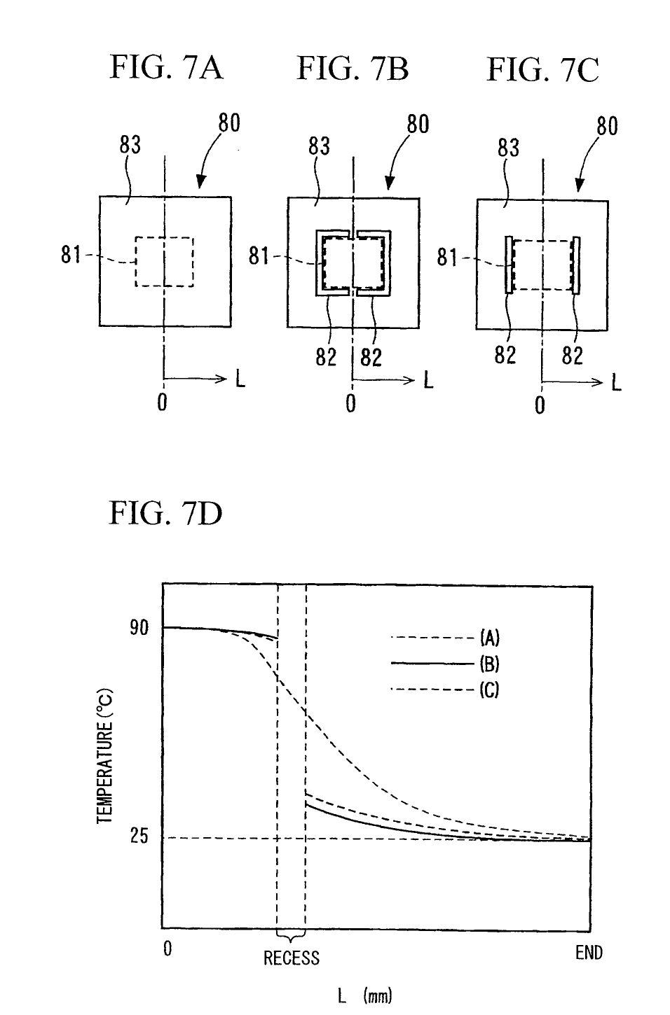

The relationships between the heat insulating effects and shapes of recesses 82, which are formed in the outer peripheries of temperature controlled portions 81 of microchips 80, will be described with reference to FIGS. 7A to 7D. FIGS. 7A to 7C diagrammatically show the microchips 80 having recesses 82 of different shapes, and FIG. 7D is a graph showing temperature distributions measured on the surfaces of the microchips 80 shown in FIGS. 7A to 7C. The microchip 80 is composed of a silicone resin (or polydimethyl-siloxane) and is formed in a rectangular shape of 35 mm width, 70 mm length, and 1.0 mm thickness. The microchip 80 is exposed to the atmosphere at a room temperature (e.g., 25° C.), and the temperature controlled portion 81 is heated at 90° C.

The microchip 80 of FIG. 7A is illustrated for the purpose of comparison, wherein no recess is formed in the outer periphery of the temperature controlled portion 81. In the microchip 80 of FIG. 7B, the temperature controlled portion 81 is surrounded by the recesses 82 except for prescribed portions matching a channel (not shown). In the microchip of FIG. 7C, a pair of recesses 82 is formed on both sides of the temperature controlled portion 81 in its width direction. Incidentally, the recesses 82 formed in the microchips 80 of FIGS. 7B and 7C are formed to run through chip bases 83 in their thickness directions.

FIG. 7D shows temperature distributions ranging from the center to the end of the aforementioned microchips 80 in their width directions, wherein the horizontal axis represents a length L (mm) measured from the center (i.e., an origin 0) to the end of the microchip 80 in its width direction, and the vertical axis represents temperature. FIG. 7D clearly shows that, in each of the microchips 80 of FIGS. 7B and 7C, the recesses 82 suppress the temperature reduction of the temperature controlled portion 81, thus suppressing the temperature increase in the external areas of the recesses 82. Herein, the microchip 80 of FIG. 7C, in which no recess is formed in both sides of the temperature controlled portion 81 in its length direction, must be reduced in heat insulating effect in comparison with that of the microchip 80 of FIG. 7B.

As described above, it is preferable that the recesses 82 be formed in relatively wide areas surrounding the temperature controlled portion 81 in order to increase the heat insulating effects.

Incidentally, the aforementioned description is given with respect to the overheating of the temperature controlled portion of the microchip of the present invention. Of course, the present invention effectively works with respect to the cooling of the temperature controlled portion of the microchip.

Lastly, the present invention is not necessarily limited to the aforementioned embodiment and variations, which are illustrative and not restrictive; hence, the present invention can be further modified within the scope of the invention as defined by the appended claims.

What is claimed is:

1. A microchip comprising:
a chip base having a thin-plate shape;
a temperature controlled portion that is installed in the chip base and is controlled in temperature; and
a heat insulator that is formed in an outer periphery of the temperature controlled portion on the chip base.

2. A microchip according to claim 1, wherein the heat insulator is realized using air.

3. A microchip according to claim 1 further comprising a channel interconnected with the temperature controlled portion on the chip base, wherein the heat insulator is formed around the temperature controlled portion except for a prescribed portion allowing the channel to pass therethrough.

4. A microchip according to claim 1, wherein the heat insulator is formed to discontinuously surround the temperature controlled portion.

5. A microchip according to claim 1, wherein the heat insulator is formed to continuously surround the temperature controlled portion.

6. A microchip according to claim 1, wherein at least one recess is formed to serve as the heat insulator in the outer periphery of the temperature controlled portion.

7. A microchip according to claim 6, wherein the recess runs through the chip base in its thickness direction.

8. A microchip according to claim 6, wherein the recess is filled with a heat insulating material.
